(19) United States
(12) Patent Application Publication
(10) Pub. No.: US 2009/0267875 A1
(43) Pub. Date: Oct. 29, 2009

(54) AUTO-ADDRESSING METHOD FOR SERIES CIRCUIT AND AUTO-DETECTING METHOD FOR DETECTING THE NUMBER OF CIRCUITS CONNECTED IN SERIES

(75) Inventors: Lee-Chun Guo, Tainan City (TW); Ming-Hsun Sung, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ITE TECH. INC., Hsinchu (TW)

(21) Appl. No.: 12/138,450

(22) Filed: Jun. 13, 2008

(30) Foreign Application Priority Data
Apr. 29, 2008 (TW) 97115794

(51) Int. Cl. G09G 3/32

(52) U.S. Cl. 345/82

(57) ABSTRACT

An auto-addressing method for a series circuit and an auto-detecting method for detecting the number of circuits connected in series are disclosed. The series circuit includes a number of same integrated circuits connected in series. The auto-detecting method is based on the auto-addressing method. In the auto-addressing method, the integrated circuits are enabled to transmit an initial address command sequentially. Each integrated circuit is provided with corresponding address information upon receiving the initial address command.

### CROSS-REFERENCE TO RELATED APPLICATION

This application claims the priority benefit of Taiwan application serial no. 97115794, filed on Apr. 29, 2008. The entirety of the above-mentioned patent application is hereby incorporated by reference herein and made a part of specification.

### BACKGROUND OF THE INVENTION

1. Field of the Invention

The present invention generally relates to an auto-addressing method and an auto-detecting method, and more particularly, to an auto-addressing method for a series circuit and an auto-detecting method for detecting the number of circuits connected in series.

2. Description of Related Art

Many electronic devices, such as, light emitting diode (LED) display panels, image sensor arrays, adopt a large amount of same integrated circuits (IC) to operate. For example, in addition to a large amount of LEDs, an LED display panel also includes a large amount of driver ICs to drive these LEDs and a few control ICs to control the operation of these driver ICs.

In order to reduce the component cost of the large amount of the same ICs and reduce the size of the IC of these electronic devices, designers usually reduce the pin count of the ICs as much as possible in designing these types of ICs. This not only can effectively reduce the size and cost of the ICs, but also can simplify the way the control ICs control the operation of the driver ICs. However, also because of the limited pin count of the ICs, the ICs in the electronic devices are usually connected in series and have no respective address information. As a result, many operations may be performed repeatedly, which results in a low operation efficiency. This will be described in more detail in connection with driver ICs of the LED display panel below.

FIG. 1 illustrates a schematic circuit structure of an LED display panel. Referring to FIG. 1, the circuit structure includes a control IC 102 and four driver ICs, as indicated by 104, 106, 108 and 110, respectively, for driving respective LEDs. In addition, in this figure, “IN” denotes a data input terminal of the IC, “OUT” denotes a data output terminal of the IC, “CMO” denotes a command output terminal of the IC, and “CMI” denotes a command input terminal of the IC. When update of data display is desired, data will be outputted via the data output terminal OUT of the control IC 102 and transmitted sequentially along the driver ICs in an order in which these driver ICs are arranged. When the data of each driver IC has been transmitted to a respective predetermined address, the control IC 102 will output a specific command to notify all the driver ICs to display the data to be displayed. This way of data transmission can not only be used to transmit display data, but also be used to set various states of state registers inside the driver ICs. Since the control IC 102 and the four driver ICs are connected to form a loop structure, the control IC 102 can further read the states of all driver ICs through this loop structure for the purpose of error detection or system inspection.

However, under this circuit structure, because no driver IC has corresponding address information, all driver ICs receive simultaneously any command sent from the command output terminal CMO of the control IC 102. Therefore, all driver ICs have to be reset whether the command is to update the display data, or to set or read the states of the driver ICs. For example, even if only one of the four driver ICs needs to update display data, under this circuit structure, the control IC 102 still must repeatedly transmit the display data of all driver ICs. This repeating operation results in a low efficiency of data transmitting.

### SUMMARY OF THE INVENTION

Accordingly, the present invention is directed to an auto-addressing method for a series circuit that can set the address information of a plurality of integrated circuits connected in series.

The present invention is also directed to an auto-detecting method for detecting the number of the integrated circuits connected in series.

In one aspect, an auto-addressing method for a series circuit is provided. The series circuit includes a plurality of same integrated circuits connected in series. In this method, the integrated circuits are enabled to sequentially transmit an initial address command. Each integrated circuit is provided with corresponding address information once each integrated circuit receives the initial address command.

In another aspect, an auto-detecting method for detecting the number of circuits of a series circuit is provided. The series circuit includes a plurality of same circuits connected in series. In this method, the integrated circuits are enabled to transmit sequentially an initial address command. Each integrated circuit is provided with corresponding address information once each integrated circuit receives the initial address command, wherein the address information of the integrated circuits has a specific relationship therebetween. The number of the integrated circuits is then calculated based on the address information of a last one of the integrated circuits and the specific relationship when the last one of the integrated circuits transmits the initial address command.

According to one embodiment of the auto-addressing method and auto-detecting method, the initial address command is provided by a control circuit.

According to one embodiment of the auto-addressing method and auto-detecting method, in addition to receiving the initial address command, a first integrated circuit of the integrated circuits also receives the corresponding address information provided by the control circuit, and the corresponding address information of each subsequent integrated circuit is provided by a previous integrated circuit.

According to one embodiment of the auto-addressing method and auto-detecting method, a first integrated circuit of the integrated circuits is coupled to a predetermined voltage and generates the initial address command based on the predetermined voltage.

According to one embodiment of the auto-addressing method and auto-detecting method, when the first integrated circuit generates the initial address information, the first integrated circuit provides its own address information itself, and the corresponding address information of each subsequent integrated circuit is provided by a previous integrated circuit.

According to one embodiment of the auto-addressing method and auto-detecting method, the corresponding address information of each integrated circuit is provided by a control circuit.

In the present invention, the integrated circuits of the series circuit transmit an initial address command sequentially, and each integrated circuit is provided with corresponding address information upon receiving the initial address command, whereby all integrated circuits can be addressed. In addition, if the address information provided to the integrated circuits has a specific relationship therebetween, when the last one of the integrated circuits transmits the initial address command, the number of the integrated circuits can be calculated based on the address information of the last one of the integrated circuits and the specific relationship. Once all integrated circuits have been addressed, the integrated circuit with a specific address can be designated to operate, such that many operations will not be repeated, thus increasing the efficiency of operation.

In order to make the aforementioned and other features and advantages of the present invention more comprehensible, embodiments accompanied with figures are described in detail below.

### BRIEF DESCRIPTION OF THE DRAWINGS

FIG. 1 illustrates a schematic structure of an LED display panel.

FIG. 2 illustrates a loop structure same as that of FIG. 1.

FIG. 3 illustrates a loop structure same as that of FIG. 2.

FIG. 4 illustrates a flow chart of an auto-addressing method for a series circuit according to one embodiment of the present invention.

FIG. 5 illustrates a flow chart of an auto-detecting method for detecting the number of circuits connected in series according to one embodiment of the present invention.

FIG. 6 illustrates another loop structure.

### DESCRIPTION OF THE EMBODIMENTS

### First Embodiment

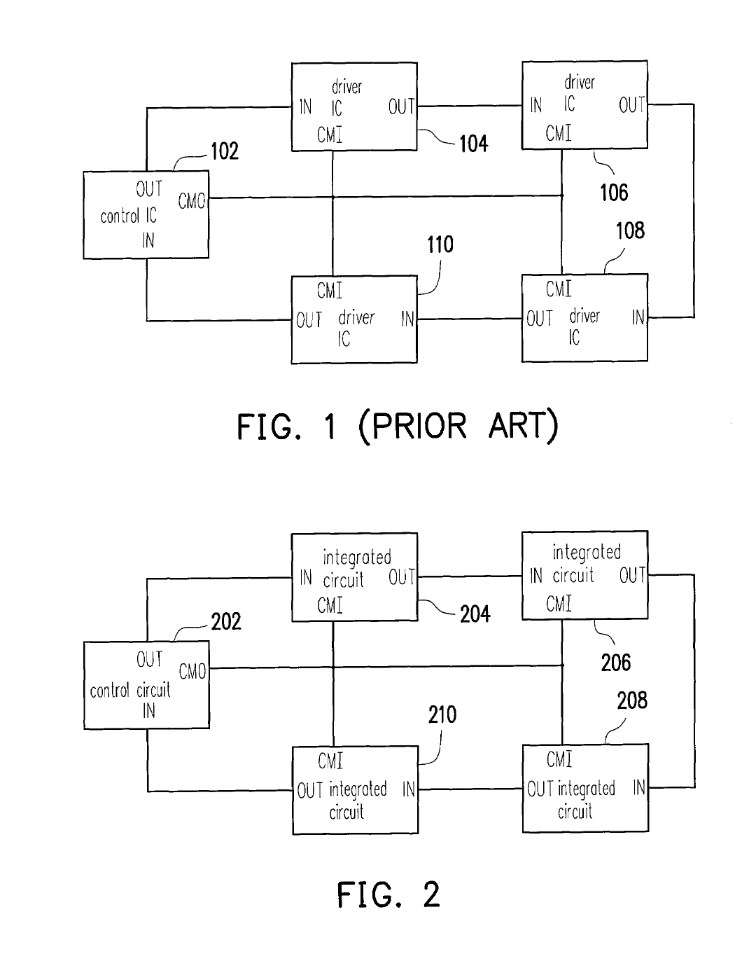

FIG. 2 illustrates a device with a same loop structure shown in FIG. 1. Referring to FIG. 2, the structure includes a control circuit 202 and four integrated circuits (ICs) connected in series, as indicated by 204, 206, 208, and 210, respectively. In addition, in this figure, “IN” denotes a data input terminal of the circuit, “OUT” denotes a data output terminal of the circuit, “CMO” denotes a command output terminal of the circuit, and “CMI” denotes a command input terminal of the circuit. Under this structure, the control circuit 202 and four series-connected ICs can be implemented as the control IC 102 and driver ICs of FIG. 1, respectively.

As the system of this loop structure is powered on, all ICs are in an unaddressed state. Then, the control circuit 202 outputs, via its data output terminal OUT, an initial address command and address information f(1) of the IC 204. The IC 204 turns to an initial address state upon receiving the initial address command and stands by for receiving address information. After receiving the address information f(1), the IC 204 is thereby addressed as f(1). Thereafter, the IC 204 modifies the address information f(1) into f(2) that is to be used as address information of the IC 206, and transmits the initial address command and the address information f(2), via its data output terminal OUT, to the IC 206. The IC 206 turns to an initial address state upon receiving the initial address command and stands by for receiving address information. After receiving the address information f(2), the IC 206 is thereby addressed as f(2).

Afterwards, the IC 206 modifies the address information f(2) into f(3) that is to be used as address information of the IC 208, and transmits the initial address command and the address information f(3) to the IC 206. Subsequent operations are performed in a similar manner as described above, and all ICs are thereby addressed. Thus, the control circuit 202 is able to designate the IC with a specific address to operate, such as, to process data update, set states, or the like. Since the control circuit 202 outputs, via its data output terminal OUT, an operation command and a specific address at the same time, the operation command and specific address will be transmitted in an order in which the ICs are arranged. Only the IC whose address matches with the specific address considers the operation command a valid command and executes the operation command, while other ICs are merely responsible for information transmission.

In addition, since the IC 210 will transmit the initial address command and an address information f(5) to the control circuit 202, the control circuit 202 can determine that all ICs have been addressed when receiving the initial address command. Further, since the address information of the various ICs has a specific relationship therebetween, after receiving the address information f(5), the control circuit 202 can reversely calculate the address information of the IC 210 and then calculate the number of the circuits connected in series based on the address information of the IC 210 and the specific relationship.

### Second Embodiment

Referring again to FIG. 2, as the system of the loop structure is powered on, all ICs are in an unaddressed state. The control circuit 202 then outputs, via its data output terminal OUT, an initial address command so that the IC 204 turns to an initial address state after receiving the initial address command and stands by for receiving address information. The control circuit 202 then outputs, via its command output terminal CMO, address information f(1) of the IC 204 to all ICs. Since only the IC 204 is waiting for the address information, only the IC 204 will receive this address information f(1) and is thereby addressed as f(1). Thereafter, the IC 204 outputs, via its data output terminal OUT, the initial address command to the IC 206 so that the IC 206 turns to an initial address state after receiving the initial address command and stands by for receiving address information. At this time, the control circuit 202 outputs, via its command output terminal CMO, address information f(2) of the IC 206 to all ICs. Since only the IC 206 is waiting for the address information, only the IC 206 will receive this address information f(2) and is thereby addressed as f(2).

Afterwards, the IC 206 outputs, via its data output terminal OUT, the initial address command to the IC 208, and the control circuit 202 then outputs, via its command output terminal CMO, address information f(3) to the IC 208. Subsequent operations are performed in a similar manner as described above, and all ICs are thereby addressed. Thus, the control circuit 202 is able to designate the IC with a specific address to operate. In addition, after being addressed, the IC 210 will transmit the initial address command to the control circuit 202. The control circuit 202 can therefore determine that all ICs have been addressed. Since the address information of the various ICs that sends out by the control circuit 202 has a specific relationship, the control circuit 202 can calculate the number of the circuits connected in series based on the address information of the IC 210 and the specific relationship.

### Third Embodiment

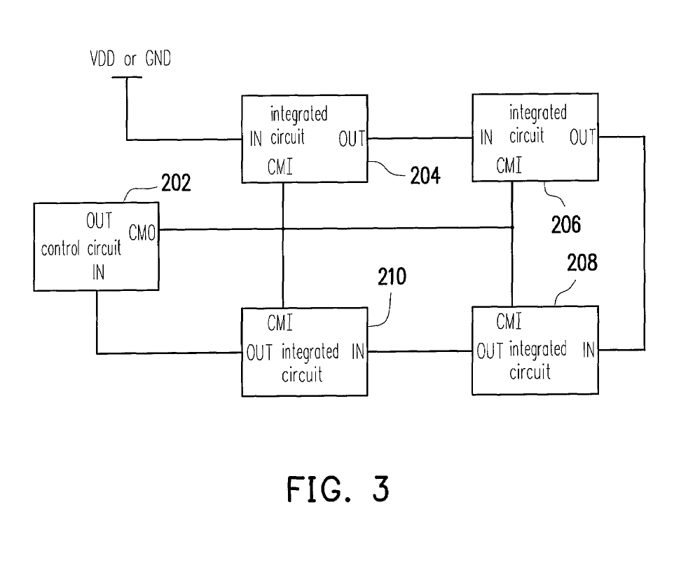

FIG. 3 illustrates a device with a loop structure similar to FIG. 2. Referring to FIG. 3, the structure likewise includes a control circuit 202 and four ICs connected in series, as indicated by 204, 206, 208, and 210, respectively. In addition, in this figure, “IN”, “OUT”, “CMO” and “CMI” denote a data input terminal of the circuit, a data output terminal of the circuit, a command output terminal of the circuit, and a command input terminal of the circuit, respectively. Referring to FIGS. 2 and 3, it can be found by comparison that, instead of being coupled to the data output terminal OUT of the control circuit 202, the data input terminal IN is connected to a predetermined voltage, such as, a power supply voltage VDD or a ground voltage GND.

As the system of this loop structure is powered on, all ICs are in an unaddressed state. At this time, the IC 204 will detect whether the data input terminal IN is coupled to the predetermined voltage. If it is determined that the data input terminal In is coupled to the predetermined voltage, the IC 204 then generates an initial address command, and provides its own address information f(1) to address itself as f(1). Thereafter, the IC 204 modifies the address information f(1) into f(2) that is to be used as address information of the IC 206, and transmits, via its data output terminal OUT, the initial address command and the address information f(2) to the IC 206. The IC 206 turns to an initial address state upon receiving the initial address command and stands by for receiving address information. After receiving the address information f(2), the IC 206 is thereby addressed as f(2). The IC 206 then modifies the address information f(2) into f(3) that is to be used as address information of the IC 208, and transmits the initial address command and the address information f(3) to the IC 208. Subsequent operations are performed in a similar manner as described above, and all ICs are thereby addressed.

In addition, since the IC 210 will transmit the initial address command and address information f(5) to the control circuit 202, the control circuit 202 can determine that all ICs have been addressed when receiving the initial address command. Further, since the address information of the various ICs has a specific relationship, after receiving the address information f(5), the control circuit 202 can reversely calculate the address information of the IC 210 and then calculate the number of the circuits connected in series based on the address information of the IC 210 and the specific relationship.

### Fourth Embodiment

Referring to FIG. 3, as the system of the loop structure is powered on, all ICs are in an unaddressed state. At this time, the IC 204 will detect whether the data input terminal IN is coupled to the predetermined voltage. If it is determined that the data input terminal IN has been coupled to the predetermined voltage, the IC 204 generates an initial address command, thereby turning to an initial address state and standing by for receiving address information. The control circuit 202 then outputs, via its command output terminal CMO, the address information f(1) to all ICs. Since only the IC 204 is standing by for receiving the address information f(1), only the IC 204 receives the address information f(1) and is thereby addressed as f(1). Thereafter, the IC 204 transmits the initial address command to the IC 206 via its data output terminal OUT so that the IC 206 turns to an initial address state and stands by for receiving address information upon receiving the initial address command. At this time, the control circuit 202 outputs the address information f(2) of the IC 206 to all ICs via its command output terminal CMO. Since only the IC 206 is standing by for receiving the address information f(2), only the IC 206 receives the address information f(2) and is thereby addressed as f(2). Subsequent operations are performed in a similar manner as described above, and all ICs are thereby addressed. The control circuit 202 is thus able to designate the IC with a specific address to operate.

In addition, since the IC 210, after being addressed, will transmit the initial address command to the control circuit 202, the control circuit 202 can determine that all ICs have been addressed. Further, since the address information of the various ICs outputted by the control circuit 202 has a specific relationship, the control circuit 202 can calculate the number of the circuits connected in series based on the address information of the IC 210 and the specific relationship.

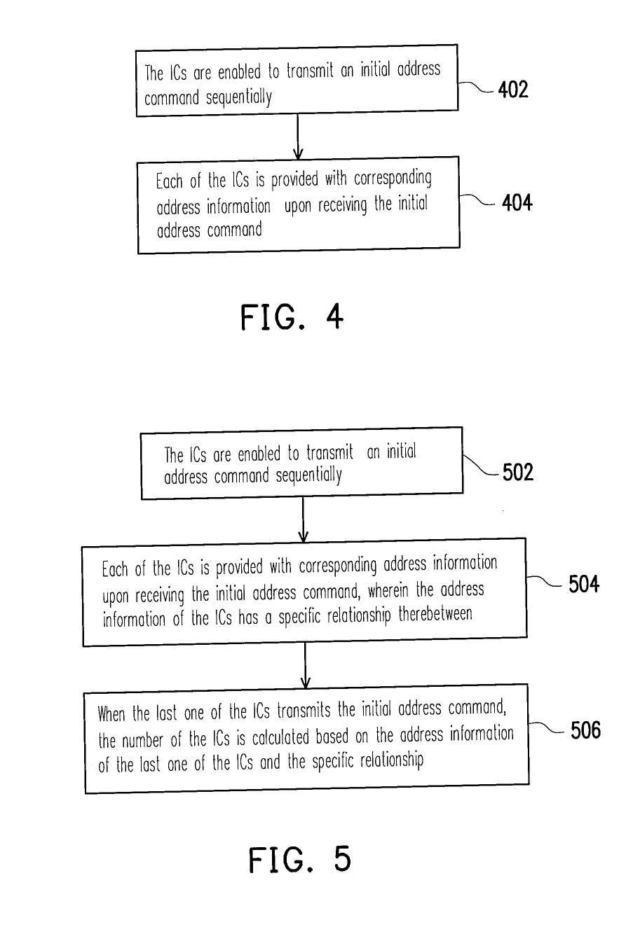

Another aspect of the invention provides an auto-addressing method for a series circuit, which is adapted for a series circuit including a plurality of same ICs connected in series. The auto-addressing method may be induced from the operations of the embodiments described above. FIG. 4 illustrates a flow chart of an auto-addressing method for a series circuit according to one embodiment of the present invention. Referring to FIG. 4, in this method, these ICs are first enabled to transmit an initial address command sequentially (step 402). Each of the ICs is provided with corresponding address information (step 404) upon receiving the initial address command.

Yet another aspect of the invention provides an auto-detecting method for detecting the number of the circuits connected in series, which likewise is adapted for a series circuit including a plurality of same ICs connected in series. The auto-addressing method may also be induced from the operations of the embodiments described above. FIG. 5 illustrates a flow chart of the auto-detecting method for detecting the number of the circuits connected in series according to one embodiment of the present invention. Referring to FIG. 5, in this method, these ICs are enabled to transmit sequentially an initial address command (step 502). Each of the ICs is provided with corresponding address information upon receiving the initial address command, wherein the address information of the ICs has a specific relationship therebetween (step 504). When the last one of the ICs transmits the initial address command, the number of the ICs is calculated based on the address information of the last one of the ICs and the specific relationship (step 506).

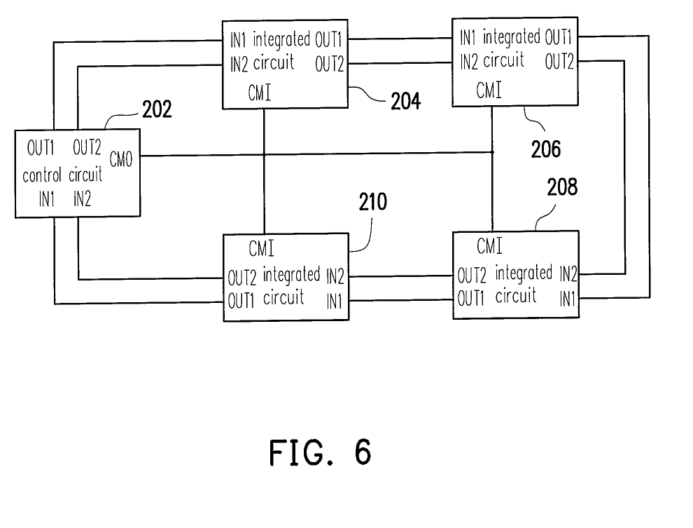

Although in the devices of the embodiments described above, connection between the various elements only transmits data of one bit, it is to be understood by those skilled in the art that the present invention is also applicable in devices having other bus width of the connection between the various elements. For example, the data bus width of the device shown in FIG. 2 can be modified to form another loop structure as illustrated in FIG. 6. Referring to FIGS. 2 and 6, it can be found by comparison that each component of FIG. 6 has two data input terminals (e.g., IN1, IN2) and two data output terminals (e.g., OUT1, OUT2), such that each component can receive or output data of two bits at the same time. In addition, while the devices of the above embodiments are illustrated as having four ICs, it is to be understood that the present invention is also applicable in devices having other number of the ICs.

In summary, in the present invention, the ICs of the series circuit sequentially transmit an initial address command, and each IC is provided with corresponding address information upon receiving the initial address command, whereby all ICs can be addressed. In addition, if the address information provided to the ICs has a specific relationship, when the last one of the ICs transmits the initial address command, the number of the ICs can be calculated based on the address information of the last one of the ICs and the specific relationship. Once all ICs have been addressed, the IC with a specific address can be designated to operate, such that many operations will not be repeated, thus improving the efficiency of operation. Further, with the auto-addressing technology, the use and maintenance of each IC of the series circuit can be more flexible.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto-addressing method for a series circuit including a plurality of same integrated circuits connected in series, comprising:
enabling the integrated circuits to sequentially transmit an initial address command; and
providing each integrated circuit with corresponding address information once the each integrated circuit receives the initial address command.

2. The method according to claim 1, wherein the initial address command is provided by a control circuit.

3. The method according to claim 2, wherein in addition to receiving the initial address command, a first integrated circuit of the integrated circuits also receives the corresponding address information provided by the control circuit, and the corresponding address information of each subsequent integrated circuit is provided by a previous integrated circuit.

4. The method according to claim 1, wherein a first integrated circuit of the integrated circuits is coupled to a predetermined voltage and generates the initial address command based on the predetermined voltage.

5. The method according to claim 4, wherein when the first integrated circuit generates the initial address information, the first integrated circuit provides its own address information itself, and the corresponding address information of each subsequent integrated circuit is provided by a previous integrated circuit.

6. The method according to claim 1, wherein the corresponding address information of each integrated circuit is provided by a control circuit.

7. An auto-detecting method for detecting the number of circuits of a series circuit, the series circuit including a plurality of same integrated circuits connected in series, the method comprising:
enabling the integrated circuits to transmit sequentially an initial address command;
providing each integrated circuit with corresponding address information once the each integrated circuit receives the initial address command, wherein the address information of the integrated circuits has a specific relationship therebetween; and
calculating the number of the integrated circuits based on the address information of a last one of the integrated circuits and the specific relationship when the last one of the integrated circuits transmits the initial address command.

8. The method according to claim 7, wherein the initial address command is provided by a control circuit.

9. The method according to claim 8, wherein, in addition to receiving the initial address command, a first integrated circuit of the integrated circuits also receives the corresponding address information provided by the control circuit, and the corresponding address information of each subsequent integrated circuit is provided by a previous integrated circuit.

10. The method according to claim 7, wherein a first integrated circuit of the integrated circuits is coupled to a predetermined voltage and generates the initial address command based on the predetermined voltage.

11. The method according to claim 10, wherein when the first integrated circuit generates the initial address information, the first integrated circuit provides its own address information itself, and the corresponding address information of each subsequent integrated circuit is provided by a previous integrated circuit.

12. The method according to claim 7, wherein the corresponding address information of each integrated circuit is provided by a control circuit.
